(19) United States
(12) Patent Application Publication
(10) Pub. No.: US 2014/0186640 A1
(43) Pub. Date: Jul. 3, 2014

(54) ANTI-ADHESION TRANSPARENT THIN FILM AND METHOD FOR FORMING THE SAME

(71) Applicant: METAL INDUSTRIES RESEARCH & DEVELOPMENT CENTRE, (US)

(72) Inventors: SUNG-MAO CHIU, KAOHSIUNG CITY (TW); CHIA-HUNG HOANG, TAOYUAN COUNTY (TW); KUO-YUAN YANG, KAOHSIUNG CITY (TW); MEI-JUNG HO, KAOHSIUNG CITY (TW)

(73) Assignee: METAL INDUSTRIES RESEARCH & DEVELOPMENT CENTRE, KAOHSIUNG CITY (TW)

(21) Appl. No.: 13/727,747

(22) Filed: Dec. 27, 2012

(51) Int. Cl. C09D 5/00

(52) U.S. Cl. CPC C09D 5/00
USPC 428/448; 428/688; 428/426; 428/446; 428/457; 428/696; 427/529; 106/2

(57) ABSTRACT

The present invention provides an anti-adhesion transparent thin film, which uses physical vapor deposition to deposit a transparent thin film on the surface of a substrate. The transparent film has the characteristics of high light perviousness, good hardness, excellent acid resistivity, and superior anti-adhesion capability. Furthermore, an oxide layer can be formed between the surface of the substrate and the transparent thin film for improving the stability of the transparent thin film adhering to the surface of the substrate. In addition, the process temperature according to the present invention is less than 100; and the transparent thin film according to the present invention requires no metal- or fluorine-containing precursor. Thereby, the costs for industrial applications can be reduced substantially. It is also suitable for the substrates with less temperature tolerance such as metal, nonmetal, and polymer-like substrates. Hence, the applicable industries are extensive.

### FIELD OF THE INVENTION

The present invention relates generally to a thin film, and particularly to a fluoride-containing anti-adhesion transparent thin film prepared by physical vapor deposition and the method for forming the same.

### BACKGROUND OF THE INVENTION

Currently, optical devices are extensively used. For example, eyeglasses, cameras, camcoders, and displays are applications of optical devices. When light is incident to different media, transmission, absorption, and reflection phenomena occur. Nonetheless, excess reflection of light causes interference and thus further affecting visual judgments. In the applications requiring vision for judging differences, the interference of excess reflection light may lead to false judgments. For instance, the color of the lens of a camera may appear dim due to excess reflection light. Consequently, the user of the camera cannot extract the color and luster of images via the lens correctly. Thereby, an anti-reflection film is deposited on the lens of an optical device for reducing the reflectivity of the optical device. As a result, the incident light transmitting the optical device is enhanced and the influence of reflection light on visual perception can be avoided.

According to the prior art, the anti-reflection film applied to lenses includes the single-layer and the multi-layer film designs. For the single-layer film design, vapor deposition is usually adopted for preparing magnesium fluoride (MgF₂). However, MgF₂ has lower hardness and thereby is less wear-resisting. On the other hand, the multi-layer design is usually to stack multiple layers of films on the lens sequentially. Adjacent films have different values of refractivity. For example, the multiple layers including SiO₂, TiO₂, SiO₂, TiO₂, . . . , films are stacked on the surface of the lens sequentially; the refractivity of the SiO₂ layers is less than that of the TiO₂ layers. By interlacing proper thickness of films with high and low refractivity, the reflection waves of the incident light form destructive interference. Thereby, the reflection light is reduced and the anti-reflection effect is achieved. Nonetheless, the disadvantages of the multi-layer design are accurate process control and extremely accurate and expensive equipment for attaining the required optical characteristics for anti-reflection.

In addition, the anti-reflection film for optical applications is normally disposed outside the optical device and exposed to the external environment. Thereby, it usually happens that foreign matters may adhere to the surface. When foreign matters adhere to the anti-reflection film, the original optical characteristics will degrade substantially and leading to abnormal operations of the optical devices. The ability of anti-adhesion of foreign matter for current anti-reflection films is insufficient, especially for endoscope applications. An endoscope uses a thin and long optical lens to enter a human body via the existing holes for observing the internal organs with minimum harm. During the operation process, it is unavoidable to touch the internal tissues of the human body. The first to be affected during the process is the lens of the endoscope. The lens according to the prior art has an anti-reflection film on its surface. Unfortunately, the film has no anti-adhesion capability at present. Thereby, during the operating process, the endoscope will be interfered continuously.

For example, Taiwan Patent Number 1293126 titled “Anti-Reflection Film and Method for Manufacturing the Same” uses hydrolysis and condensation reaction to make a metal alkoxide or metal inorganic salts to form a colloid for manufacturing a layer of thin film or a plurality layers of thin films and forming an anti-reflection film. At first, a metal alkoxide or a metal inorganic salt is used for performing hydrolysis and condensation reaction and producing a colloid. Next, resolve the colloid in an organic solution so that the colloid can react uniformly after being added into the reactor with the organic solution. Then a photoinitiator is added to make the colloid start to react in the reactor. Finally, the mixed solution produced in the reactor is spin coated on a transparent substrate and thus forming an anti-reflection film on the transparent substrate. Nonetheless, the spin coating method disclosed in the prior art faces the problem of thickness nonuniformity. Besides, the temperature for vaporizing the solvent or drying the thin film can be as high as over 300. For the materials with insufficient heat resistance, this method is not applicable. In addition, the thin film formed in this method does not own the property of anti-adhesion.

Moreover, Taiwan Patent number 1302549 titled “Perfluoropolyether-Modified Silane, Surface Treating Agent, and Antireflection Filter” is an anti-reflection filter containing inorganic anti-reflection layers, which include a surface layer of inorganic layer mainly in silicon dioxide and an anti-foul on the surface layer. The anti-foul layer is preferably perfluoropolyether-modified silane. The anti-foul layer has low surface energy and the lowest adhesion to pollutants. Thereby, it can maintain the effect for a long time and resist deposition of pollutants such as fingerprints, skin oil, sweat, and cosmetics. Even if the pollutants are adhered, the anti-foul layer makes wiping of the pollutants easy and minimum reduction in its function during wiping. Nonetheless, the anti-reflection filter disclosed in the prior art needs to have the double layer structure. In addition, its material system is main silicon dioxide; the anti-foul layer adopts perfluoropolyether-modified silane and/or its partially hydrolyzed condensation compound. The process requires many solvents, such as xylene and trifluoromethylbenzene, to participate the reactions. Thereby, it is disadvantageous to the environment.

Because current technologies cannot handle the problem perfectly, breakthrough is required. Thereby, how to enhance convenience, practicability, and economic benefit has become the major issue in the field.

Accordingly, the present invention provides an anti-adhesion transparent thin film and the method for forming the same with high convenience, practicability, and economic benefit.

### SUMMARY

An objective of the present invention is to provide an anti-adhesion transparent thin film, which has the properties of high light perviousness, good hardness, and excellent acid resistivity. Besides, the anti-adhesion transparent thin film according to the present invention has superior anti-adhesion for water, oil, and artificial human tissues. Because the concentration of fluoride doped in the thin film is relatively high, only a single-layer structure can have the function of an anti-reflection film, and thus reducing the loss in transmittance caused by reflection.

Another objective of the present invention is to provide an anti-adhesion transparent thin film, which uses physical vapor deposition to dope fluoride into the material of oxide thin film in a vacuum environment. Because no precursor containing metal or fluorine is required, the costs for industrial applications can be reduced substantially and hence suitable for batch and continuous production types. In addition, the process temperature is less than 100, and thereby making the present invention suitable for the substrates with less temperature resistance such as metal, nonmetal, and polymer-like substrates. Hence, the applicable industries are extensive.

For achieving the objectives described above, the present invention provides an anti-adhesion transparent thin film, which comprises a transparent thin film including an oxide and a fluoride.

Moreover, for achieving the objectives described above, the present invention provides a method for forming an anti-adhesion transparent thin film, which comprises steps of providing a substrate in a vacuum environment; providing a target in the vacuum environment; aerating a fluoride gas and oxygen into the vacuum environment and mixing with a plurality of ions formed by plasma ionization of the target, and the plurality of ions and the oxygen reacting and producing an oxide; and depositing the fluoride and the oxide on the substrate.

### BRIEF DESCRIPTION OF THE DRAWINGS

FIG. 1 shows a structural cross-sectional view according the first preferred embodiment of the present invention;

FIG. 2 shows a structural cross-sectional view according the second preferred embodiment of the present invention;

FIG. 3 shows a flowchart according the first preferred embodiment of the present invention;

FIG. 4 shows a flowchart according the second preferred embodiment of the present invention;

FIG. 5A compares experimental results (1) of repellence for water and for artificial joint fluid according to the present invention;

FIG. 5B compares experimental results (2) of repellence for water and for artificial joint fluid according to the present invention;

FIG. 6A shows a transmittance curve of the titanium dioxide without fluoride according to the present invention;

FIG. 6B shows a transmittance curve of the titanium dioxide lightly doped with fluoride according to the present invention; and

FIG. 6C shows a transmittance curve of the titanium dioxide heavily doped with fluoride according to the present invention.

### DETAILED DESCRIPTION

In order to make the structure and characteristics as well as the effectiveness of the present invention to be further understood and recognized, the detailed description of the present invention is provided as follows along with embodiments and accompanying figures.

Because the optical film is usually exposed to the external environment, foreign matters tend to adhere thereto. The foreign matters will degrade the original optical characteristics substantially and thus leading to abnormal operations of the optical device. When the anti-reflection film is applied to the lens of an endoscope, after the lens is inserted into a human body, the human tissues tend to adhere to the lens, and block the operations of the endoscope and limit the pictures taken through the lens. In addition, there is no anti-reflection film and its forming method according to the prior art having the structure of single layer, anti-adhesion, and high transmittance. Accordingly, the present invention provide a technology for solving the drawbacks in the prior art.

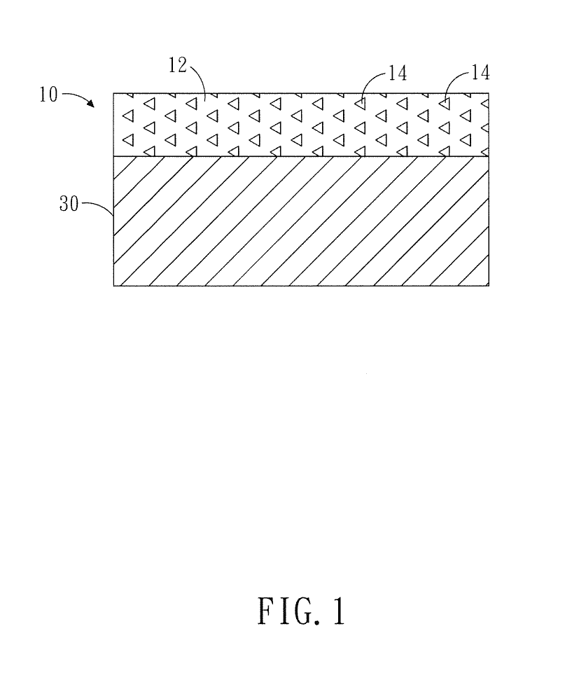

First, FIG. 1 shows a structural cross-sectional view according the first preferred embodiment of the present invention. As shown in the figure, the present embodiment comprises a transparent thin film 10. The composition of the transparent thin film 10 includes an oxide 12 and a fluoride 14 both deposited on the surface of a substrate 30.

The oxide 12 can be a metal oxide or a nonmetal oxide. The oxide 12 is selected from the group consisting of tin oxide, indium oxide, zirconium oxide, silicon oxide, copper oxide, lead oxide, titanium dioxide, mercury oxide, zinc oxide, and barium oxide. The fluoride 14 is a compound containing fluorine, oxygen, and carbon.

The atomic percentage of the fluorine atoms of the fluoride 14 in the transparent thin film 10 is 0.2˜20 at. %. The oxide 12 is a metal oxide or a nonmetal oxide. The atomic percentage of the metal or the nonmetal atoms of the oxide 12 in the transparent thin film 10 is 0.5˜25 at. %. The atomic percentage of the other oxygen or carbon atoms in the transparent thin film 10 is 25˜55 at. %. The thickness of the transparent thin film 10 is approximately 100 to 5000 nanometers (nm). Particularly, the thickness of 100 to 300 nm leads to preferred transmittance in the wavelength range of the visible light.

The transparent thin film 10 is formed on the surface of the substrate 30 by physical vapor deposition. The substrate 30 can be a transparent substrate or an opaque substrate. The material of the transparent substrate is selected from the group consisting of glass, ceramic, and polymer-like materials; the material of the opaque material is selected from the group consisting of metal and tungsten carbide. The major applications of the present invention adopt transparent substrates such as optical lenses, the lenses of medical endoscopes, camera lenses, display panels, solar cells, or other substrates requiring anti-adhesion and high light perviousness.

The transparent thin film 10 is formed on the surface of a lens and has the properties of high light perviousness, good hardness, and excellent acid resistivity. Besides, it has superior anti-adhesion for water, oil, and artificial human tissues. Because it requires only a single-layer structure for achieving the function of an anti-reflection film, the loss in transmittance caused by reflection can be reduced.

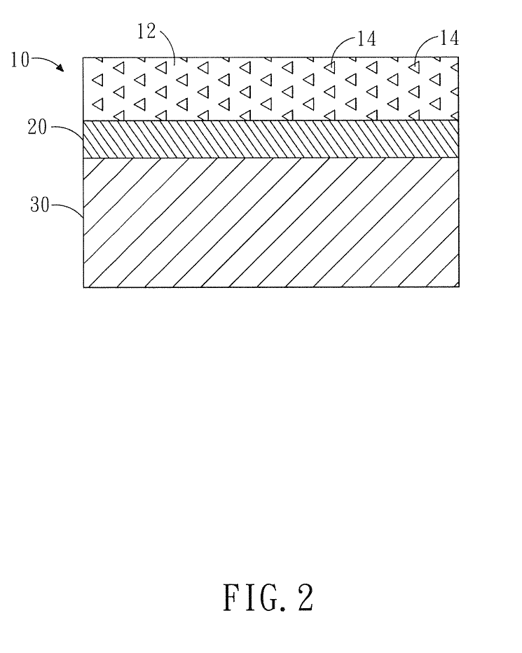

FIG. 2 shows a structural cross-sectional view according the second preferred embodiment of the present invention, which is a technical extension based on the first preferred embodiment. As shown in the figure, the difference between the present preferred embodiment and the first preferred embodiment is that according to the present preferred embodiment, an oxide layer 20, which is formed on the surface of the substrate 30 by physical vapor deposition, is further disposed between the transparent thin film 10 and the substrate 30. The material of the oxide layer 20 is selected from the group consisting of tin oxide, indium oxide, zirconium oxide, silicon oxide, copper oxide, lead oxide, titanium dioxide, mercury oxide, zinc oxide, and barium oxide. The thickness of the oxide layer 20 is 25 to 500 nm and preferably between 100 and 300 nm.

Because the oxide layer 20 has better affinity with the substrate 30, it can adhere to the surface of the substrate 30 stably and act as the binding medium between the transparent thin film 10 and the substrate 30 for reinforcing the adhesion of the transparent thin film 10. Thereby, when the substrate 30 is in severely loading condition or having some foreign matters adhered thereto, instead of peeling off from the surface of the substrate 30, the transparent thin film 10 can still adhere to the surface of the substrate 30 stably by means of the oxide layer 20.

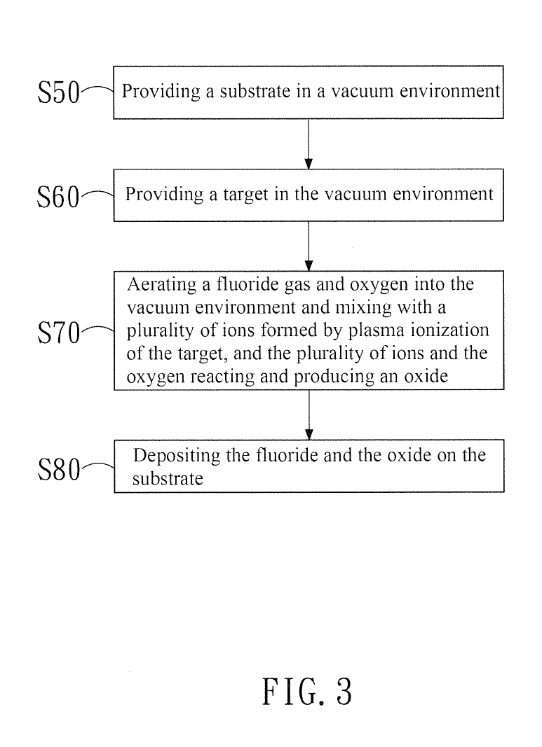

FIG. 3 shows a flowchart according the first preferred embodiment of the present invention. As shown in the figure, the method for forming the anti-adhesion transparent thin film according to the present embodiment comprises the following steps:

Step S50: Providing a substrate in a vacuum environment;

Step S60: Providing a target in the vacuum environment;

Step S70: Aerating a fluoride gas and oxygen into the vacuum environment and mixing with a plurality of ions formed by plasma ionization of the target, and the plurality of ions and the oxygen reacting and producing an oxide; and

Step S80: Depositing the fluoride and the oxide on the substrate.

The material of the target is selected from the group consisting of tin, indium, zirconium, silicon, copper, lead, titanium, mercury, zinc, and barium. The fluoride gas is selected from the group consisting of trifluoromethane (CHF₃), tetrafluoromethane (CF₄), tetrafluoroethane (C₂H₂F₄), hexafluoroethane (C₂F₆), hexafluoropropane (C₃H₂F₆), heptafluoropropane (C₃HF₇), octafluoropropane (C₃F₈), and octafluorocyclobutane (C₄F₈).

The atomic percentage of the fluorine atoms in the transparent thin film 10 is 0.2˜20 at. %. The atomic percentage of the metal atoms is 0.5˜25 at. %. The atomic percentage of the other oxygen or carbon atoms is 25˜55 at. %. The thickness of the transparent thin film 10 is approximately 100 to 5000 nm. Particularly, the thickness of 100 to 300 nm leads to preferred transmittance in the wavelength range of the visible light.

The transparent thin film 10 is formed on the surface of the substrate 30 by physical vapor deposition. The substrate 30 can be a transparent substrate or an opaque substrate. The material of the transparent substrate is selected from the group consisting of glass, ceramic, and polymer-like materials; the material of the opaque material is selected from the group consisting of metal and tungsten carbide. The major applications of the present invention adopt transparent substrates such as optical lenses, the lenses of medical endoscopes, camera lenses, display panels, solar cells, or other substrates requiring anti-adhesion and high light perviousness.

According to the present embodiment, physical vapor deposition is used. The target is vaporized and mixed with a fluoride gas and oxygen for reaction. At last, the reaction product is deposited on the surface of the substrate 30 for forming the transparent thin film 10. Because no precursor containing metal or fluorine is required, the costs for industrial applications can be reduced substantially and hence suitable for batch and continuous production types. In addition, the process temperature is less than 100, and thereby making the present invention suitable for the substrates with less temperature tolerance such as metal, nonmetal, and polymer-like substrates. Hence, the applicable industries are extensive.

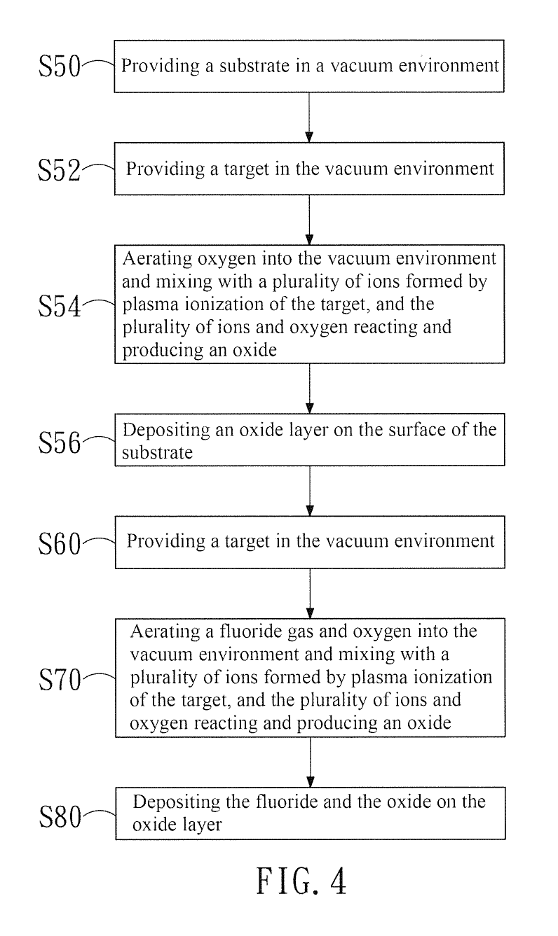

FIG. 4 shows a flowchart according the second preferred embodiment of the present invention, which is a technical extension based on the first preferred embodiment. As shown in the figure, in the method for forming the anti-adhesion transparent thin film according to the present embodiment, after the step of providing a substrate in a vacuum environment, the following further steps are included:

Step S52: Providing a target in the vacuum environment;

Step S54: Aerating oxygen into the vacuum environment and mixing with a plurality of ions formed by plasma ionization of the target, and the plurality of ions and the oxygen reacting and producing an oxide; and

Step S56: Depositing an oxide layer on the surface of the substrate.

The material of the target is selected from the group consisting of tin, indium, zirconium, silicon, copper, lead, titanium, mercury, zinc, and barium. The thickness of the oxide layer 20 is 25 to 500 nm and preferably between 100 and 300 nm.

According to the present embodiment, after providing the target and the substrate 30 in the vacuum environment, aerate oxygen into the vacuum environment and mix with the plurality of ions formed by plasma ionization of the target. Then the plurality of ions and oxygen react and produce an oxide. Finally, deposit the oxide layer 20 on the surface of the substrate. After the above steps are completed, then the steps described in the first embodiment are performed on the oxide layer 20 for reinforcing the adhesion of the transparent thin film 10. Thereby, when the substrate 30 is moving or having some foreign matters adhered thereto, instead of peeling off from the surface of the substrate 30, the transparent thin film 10 can still adhere to the surface of the substrate 30 stably by means of the oxide layer 20.

In the following, an embodiment and experimental results are provided for further describing the structure and the forming method of the present invention.

First, in a vacuum environment and proper electric filed, pure titanium (Ti) is used as the target and aerating argon (Ar) to generate a plasma environment. While forming titanium ions, aerate reactive gas oxygen (O₂) and fluorine-containing gas such as tetrafluoromethane (CF₄). Finally, deposit on the surface of the substrate and form a fluorine-containing titanium dioxide, which is just the transparent thin film according to the present invention.

In addition, before forming the fluorine-containing titanium dioxide on the surface of the substrate, a metal oxide layer can be formed first on the surface of the substrate. Pure titanium can also be used as the target for forming the metal oxide layer. Aerate argon to generate a plasma environment. While forming titanium ions, aerate reactive gas oxygen. Finally, a titanium dioxide is deposited on the surface of the substrate, and thus forming the metal oxide layer of the present invention. Afterwards, form the fluoride-containing titanium dioxide on the titanium dioxide. Then the adhesion of the fluoride-containing titanium dioxide can be enhanced.

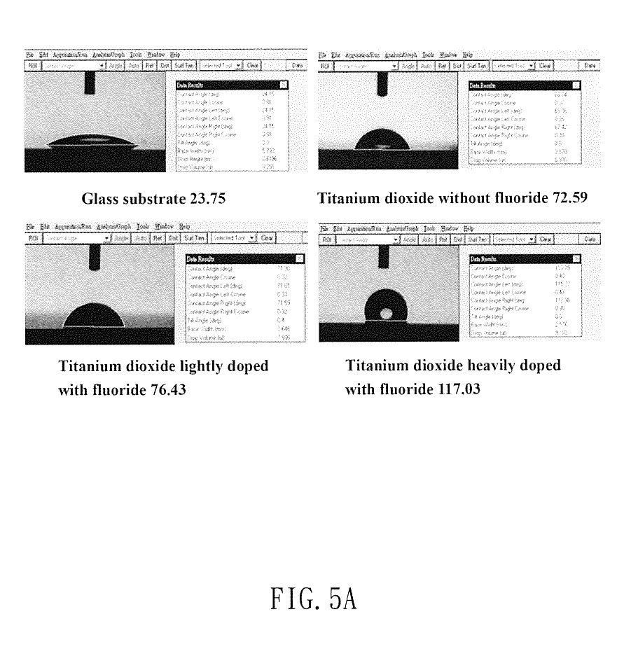

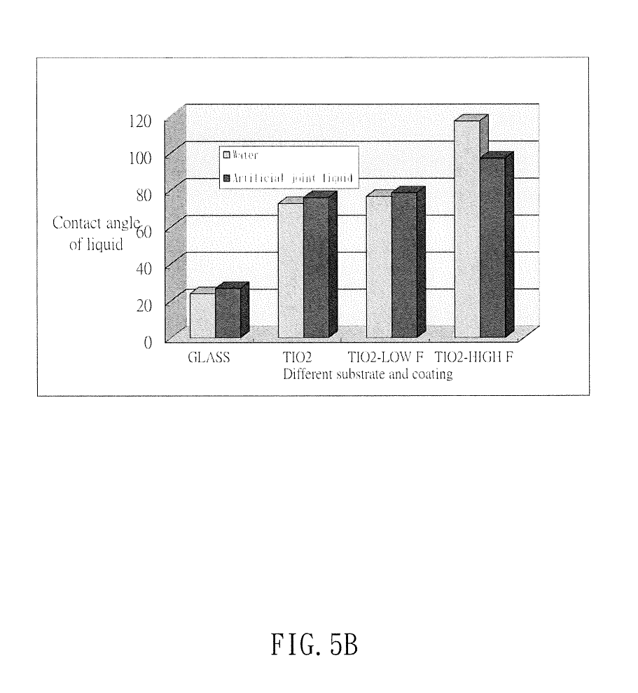

Please refer to FIG. 5A and FIG. 5B. According to the present invention, the ratio of fluoride content in the titanium dioxide is further adjusted for giving a titanium dioxide without fluoride, a titanium dioxide lightly doped with fluoride, and a titanium dioxide heavily doped with fluoride, respectively. The atomic percentage of the fluorine atoms in the titanium dioxide lightly doped with fluoride is 0.2˜2 at. %; the atomic percentage of the metal atoms is 10˜25 at. %; and the other gradients are oxygen or carbon atoms. The atomic percentage of the fluorine atoms in the titanium dioxide heavily doped with fluoride is 2˜20 at. %; the atomic percentage of the metal atoms is 0.5˜10 at. %; and the other gradients are oxygen or carbon atoms. The repellence properties for water and for artificial joint fluid of the three kinds of titanium dioxides described above together with a glass substrate are compared. It is found that the contact angle of water and artificial joint fluid on the surface of the titanium dioxide heavily doped with fluoride is greatest compared to the other surfaces. Thereby, the titanium dioxide heavily doped with fluoride has the best anti-adhesion capability.

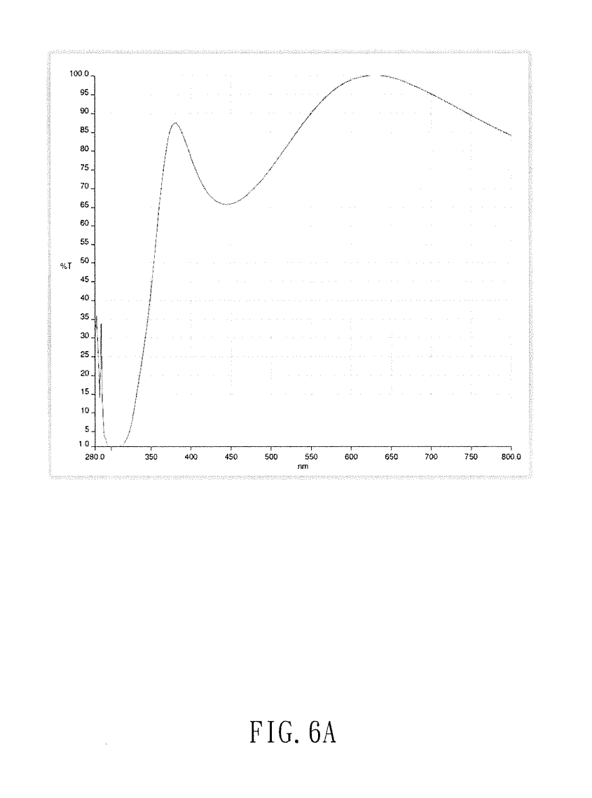

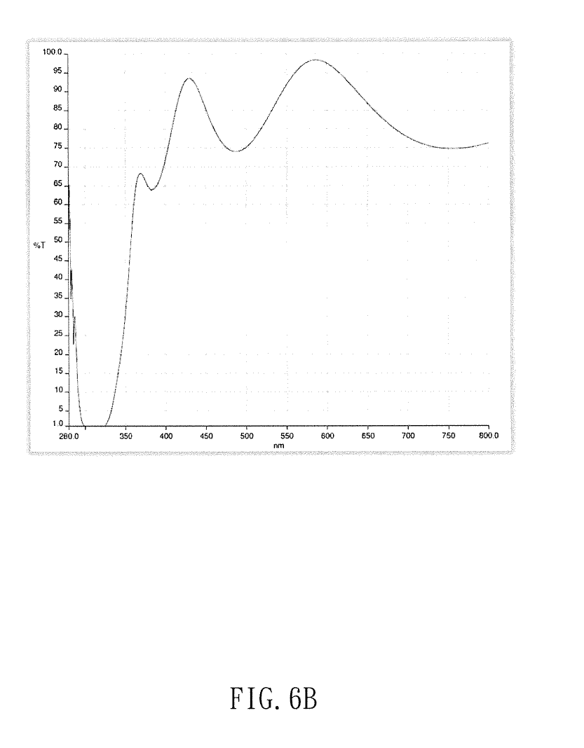

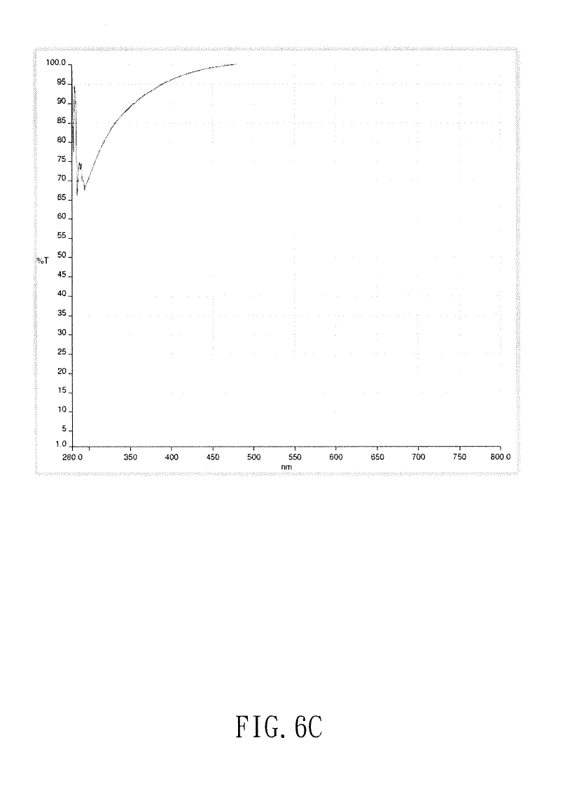

FIGS. 6A, 6B, and 6C show transmittance curves of the titanium dioxide without fluoride, lightly doped with fluoride, and heavily doped with fluoride, respectively, according to the present invention. On the present embodiment, the experiments of transmittance and anti-reflection for the titanium dioxide without fluoride, lightly doped with fluoride, and heavily doped with fluoride are compared. At the wavelength of 550 nm, the transmittance of the titanium dioxide without fluoride is 90%; the transmittance of the titanium dioxide lightly doped with fluoride is 92%; and the transmittance of the titanium dioxide heavily doped with fluoride almost reaches 100%. The refractive index of titanium dioxide is approximately 2.3; the refractive index of titanium dioxide lightly doped with fluoride is approximately 2.07; and the refractive index of titanium dioxide heavily doped with fluoride is approximately 1.37. Thereby, the titanium dioxide heavily doped with fluoride has the characteristics of a low refractive-index layer with anti-reflection capability.

In general, an endoscope is sterilized using 2% glutaraldehyde sterilizing liquid. In the present embodiment, the optical transmittance values of the fluoride-containing titanium dioxide before and after sterilization using glutaraldehyde are compared. It is found that the appearance and optical testing results of the fluoride-containing titanium dioxide after immersion remain the same without damage as before immersion. This proves that the corrosion resistivity of the fluoride-containing titanium dioxide is excellent.

The anti-reflection film according to the prior art is magnesium fluoride (MgF₂), which has lower hardness around 2.89˜-4.41 GPa. Besides, it has the drawback of being soluble in acid. These drawbacks limit its application to medical equipment. On the contrary, the fluoride-containing titanium dioxide according to the present embodiment has hardness as high as 10.86 GPa, enabling it with high wear resistivity. Apparently, the fluoride-containing titanium dioxide according to the present invention is superior to the anti-reflection film according to the prior art.

To sum up, the present invention uses physical vapor deposition to form a transparent thin film, which is a fluoride-containing oxide, on the surface of a substrate. Furthermore, an oxide layer is formed between the surface of the substrate and the transparent thin film for improving the stability of the transparent thin film adhering to the surface of the substrate. The anti-adhesion transparent thin film and the method for forming the same according to the present invention have the following functions:
1. The anti-adhesion transparent thin film has the characteristics of high light perviousness, good hardness, and excellent acid resistivity. It has superior anti-adhesion capability to water, oil, and artificial human tissues.
2. The anti-adhesion transparent thin film is a single layer structure and has the function of anti-reflection. Thereby, it can reduce the loss in transmittance caused by reflection of light. It can also reduce the thickness of the anti-reflection film.
3. The forming method according to the present invention requires no metal- or fluorine-containing precursor. Thereby, the costs for industrial applications can be reduced substantially and hence suitable for batch and continuous production types.
4. The process temperature according to the present invention is less than 100, and thereby making it suitable for the substrates with less temperature tolerance such as metal, nonmetal, and high polymer substrates. Hence, the applicable industries are extensive.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. An anti-adhesion transparent thin film comprising a transparent thin film, which includes an oxide and a fluoride.

2. The anti-adhesion transparent thin film of claim 1, wherein a substrate is disposed on one side of said transparent thin film, and said substrate is a transparent substrate or an opaque substrate.

3. The anti-adhesion transparent thin film of claim 2, wherein the material of said transparent substrate is selected form the group consisting of glass, ceramic, and polymer-like materials.

4. The anti-adhesion transparent thin film of claim 2, wherein the material of said opaque substrate is selected form the group consisting of metal and tungsten carbide.

5. The anti-adhesion transparent thin film of claim 1, wherein said oxide is selected form the group consisting of tin oxide, indium oxide, zirconium oxide, silicon oxide, copper oxide, lead oxide, titanium dioxide, mercury oxide, zinc oxide, and barium oxide.

6. The anti-adhesion transparent thin film of claim 1, wherein said fluoride is a compound containing fluorine, oxygen, and carbon.

7. The anti-adhesion transparent thin film of claim 1, wherein the atomic percentage of the fluorine atoms of said fluoride in said transparent thin film is 0.2˜20 at. %; said oxide is a metal oxide or a nonmetal oxide; the atomic percentage of the metal or the nonmetal atoms of said oxide in said transparent thin film is 0.5˜25 at. %; and the atomic percentage of the other oxygen or carbon atoms in said transparent thin film is 25˜55 at. %.

8. The anti-adhesion transparent thin film of claim 2, and further comprising an oxide layer disposed between said transparent thin film and said substrate.

9. The anti-adhesion transparent thin film of claim 8, wherein said oxide layer is selected form the group consisting of tin oxide, indium oxide, zirconium oxide, silicon oxide, copper oxide, lead oxide, titanium dioxide, mercury oxide, zinc oxide, and barium oxide.

10. A method for forming an anti-adhesion transparent thin film, comprising steps of:
providing a substrate in a vacuum environment;
providing a target in said vacuum environment;
aerating a fluoride gas containing carbon and oxygen into said vacuum environment and mixing with a plurality of ions formed by plasma ionization of said target, and said plurality of ions and said oxygen reacting and producing an oxide; and
depositing a fluoride containing carbon and said oxide on said substrate.

11. The method for forming an anti-adhesion transparent thin film of claim 10, wherein said substrate is a transparent substrate or an opaque substrate.

12. The method for forming an anti-adhesion transparent thin film of claim 11, wherein a material of said transparent substrate is selected form the group consisting of glass, ceramic, and polymer materials.

13. The method for forming an anti-adhesion transparent thin film of claim 11, wherein a material of said opaque substrate is selected form the group consisting of metal and tungsten carbide.

14. The method for forming an anti-adhesion transparent thin film of claim 10, wherein a material of said target is selected form the group consisting of tin, indium, zirconium, silicon, copper, lead, titanium, mercury, zinc, and barium.

15. The method for forming an anti-adhesion transparent thin film of claim 10, wherein said fluoride gas is selected from the group consisting of trifluoromethane (CHF3), tetrafluoromethane (CF4), tetrafluoroethane (C2H2F4), hexafluoroethane (C2F6), hexafluoropropane (C3H2F6), heptafluoropropane (C3HF7), octafluoropropane (C3F8), and octafluorocyclobutane (C4F8).

16. The method for forming an anti-adhesion transparent thin film of claim 10, wherein the atomic percentage of the fluorine atoms of said fluoride is 0.2˜20 at. %; the atomic percentage of metal atoms is 0.5˜25 at. %; and the atomic percentage of other oxygen or carbon atoms is 25˜55 at. %.

17. The method for forming an anti-adhesion transparent thin film of claim 10, and after said step of providing said substrate in said vacuum environment further comprising steps of:
repeating the steps of providing a target in said vacuum environment, aerating oxygen into said vacuum environment and mixing with a plurality of ions formed by plasma ionization of said target, and said plurality of ions and said oxygen reacting and producing an oxide, and depositing an oxide layer on the surface of said substrate.

18. The method for forming an anti-adhesion transparent thin film of claim 17, wherein a material of said target is selected form the group consisting of tin, indium, zirconium, silicon, copper, lead, titanium, mercury, zinc, and barium.
